(19) United States
(12) Patent Application Publication
(10) Pub. No.: US 2011/0221407 A1
(43) Pub. Date: Sep. 15, 2011

(54) DC-DC CONVERTER AND CONTROL METHOD THEREOF

(75) Inventor: Hironao KATO, Kanagawa (JP)

(73) Assignee: Renesas Electronics Corporation, Kanagawa (JP)

(21) Appl. No.: 13/041,796

(22) Filed: Mar. 7, 2011

(30) Foreign Application Priority Data
Mar. 9, 2010 (JP) 2010-51997

(51) Int. Cl. G05F 1/56

(52) U.S. Cl. 323/271

(57) ABSTRACT

A DC-DC converter according to an aspect of the present invention includes an error generator, a mode selection reference voltage generator, an operation mode selector, and a driver controller. The error generator generates an error signal based on a direct-current output voltage. The mode selection reference voltage generator generates a first mode selection reference voltage and a second mode selection reference voltage lower than the first mode selection reference voltage. The first and second mode selection reference voltages vary based on amplitude of an alternating-current component included in the error signal. The operation mode selector compares the error signal with the first and second mode selection reference voltages. The driver controller switches a generating method of the direct-current output voltage from one of a PWM method and a PFM method to the other according to the result of the comparison.

### CROSS-REFERENCE TO RELATED APPLICATIONS

This application is based upon and claims the benefit of priority from Japanese patent application No. 2010-51997, filed on Mar. 9, 2010, the disclosure of which is incorporated herein in its entirety by reference.

### BACKGROUND

1. Field of the Invention

The present invention relates to a DC-DC converter and a control method thereof, and particularly to a DC-DC converter that switches a type of control method according to an output voltage thereof and a control method thereof.

2. Description of Related Art

A chopper type DC-DC converter is known as a converter circuit that converts a direct-current input voltage into a different direct-current output voltage. A PFM (Pulse Frequency Modulation) method and a PWM (Pulse Width Modulation) method can be introduced as control methods for keeping an output voltage of the DC-DC converter within a predetermined range.

The PFM method changes a frequency of a drive signal supplied to a switching device that controls an output voltage of a converter. According to the PFM method, a circuit configuration can be generally simplified compared with the PWM method. Particularly, in the case of a light load, the PFM method has an advantage that a use efficiency of a drive power can be increased. However, in the PFM method, a ripple voltage is high and a ripple frequency changes, so that it is difficult to eliminate a ripple. Note that the ripple indicates an alternating-current component included in the direct-current output voltage of the converter.

On the other hand, the PWM method keeps the frequency of the drive signal supplied to the switching device, and changes a pulse width of the drive signal. In this way, a drive frequency of the switching device is constant. Therefore, the ripple can be easily eliminated using a filter or the like. However, in the PWM method, the frequency of the drive signal supplied to the switching device is constant, so that the switching device is constantly driven at a predetermined timing. Accordingly, the PWM method has a disadvantage that the use efficiency of the drive power can be reduced in the case of a light load.

Thus, a DC-DC converter, which uses a drive means of the PWM method when an output load is heavy and a drive means of the PFM method when the output load is light, is proposed. This DC-DC converter monitors an error signal generated based on the output voltage, and switches an operation mode. In sum, a PFM→PWM switching is performed when the error signal increases to a reference level, and a PWM→PFM switching is performed when the error signal falls below the reference level. However, when the error signal transits near the reference level, the error signal continually fluctuates above and below the reference level. As a result, the PWM method/PFM method switching is continually performed, which causes a problem that the output voltage becomes unstable.

A DC-DC converter, which prevents the continual PWM method/PFM method switching described above, is disclosed in Japanese Unexamined Patent Application Publication No. 2003-219637. In the DC-DC converter disclosed in Japanese Unexamined Patent Application Publication No. 2003-219637, a PFM→PWM switching level is set at a level different from a PWM→PFM switching level, so that the PWM method/PFM method switching can be sluggishly performed. FIG. 8 is a graph showing an operation mode switching in the DC-DC converter disclosed in Japanese Unexamined Patent Application Publication No. 2003-219637. In FIG. 8, a mode selection reference voltage Vmh represents the PFM→PWM switching level, and a mode selection reference voltage Vml represents the PWM→PFM switching level. As shown in FIG. 8, when the error signal passes the mode selection reference voltage Vml serving as the PWM→PFM switching level and increases to the mode selection reference voltage Vmh serving as the PFM→PWM switching level, the operation mode of the DC-DC converter is switched from the PFM method to the PWM method. On the other hand, when the error signal passes the mode selection reference voltage Vmh serving as the PFM→PWM switching level and decreases to the mode selection reference voltage Vml serving as the PWM→PFM switching level, the operation mode of the DC-DC converter is switched from the PWM method to the PFM method.

### SUMMARY

However, the present inventor has found a problem described below. According to the DC-DC converter disclosed in Japanese Unexamined Patent Application Publication No. 2003-219637, the ripple of the output voltage of the DC-DC converter increases according to an increase in an input voltage. Thus, a ripple of the error signal generated based on the output voltage also increases. In this way, when the ripple of the error signal becomes larger than a width between the PWM→PFM switching level and the PFM→PWM switching level, the mode switching is continually performed.

FIG. 9 is a graph showing the operation mode switching when the input voltage of the DC-DC converter disclosed in Japanese Unexamined Patent Application Publication No. 2003-219637 is low. When the input voltage is low, the ripple of the error signal is smaller than a width between the mode selection reference voltage Vmh and the mode selection reference voltage Vml (hereinafter, it is referred as hysteresis width Vhy. In sum, Vhy=Vmh−Vml). In this case, the operation mode is stable.

FIG. 10 is a graph showing the operation mode switching when the input voltage of the DC-DC converter disclosed in Japanese Unexamined Patent Application Publication No. 2003-219637 is high. When the input voltage is high, the ripple of the error signal becomes too large to be ignored with respect to the hysteresis width Vhy. When the ripple of the error signal becomes larger enough to traverse the hysteresis width, the operation mode is continually switched and the operation becomes unstable. Therefore, it is impossible to achieve the operation mode stabilization according to an input voltage variation in the DC-DC converter disclosed in Japanese Unexamined Patent Application Publication No. 2003-219637.

A first aspect of the present invention is a DC-DC converter including: an error generator that generates an error signal based on a direct-current output voltage; a mode selection reference voltage generator that generates a first mode selection reference voltage and a second mode selection reference voltage lower than the first mode selection reference voltage, the first and second mode selection reference voltages varying based on amplitude of an alternating-current component included in the error signal; an operation mode selector that compares the error signal with the first and second mode selection reference voltages; and a driver controller that switches a generating method of the direct-current output voltage from one of a PWM method and a PFM method to the other according to the result of the comparison. According to the DC-DC converter in accordance with a first aspect of the present invention, the first and second mode selection reference voltages decrease associated with an increase in a direct-current input voltage. Therefore, an operation mode can be switched in a region in which the alternating-current component (ripple) included in the error signal is small. Thus, an operation of the DC-DC converter can be stable.

A first aspect of the present invention is a control method of a DC-DC converter including: generating an error signal based on a direct-current output voltage; changing a first mode selection reference voltage and a second mode selection reference voltage lower than the first mode selection reference voltage based on amplitude of an alternating-current component included in the error signal; comparing the error signal with the first and second mode selection reference voltages; and switching a generating method of the direct-current output voltage from one of a PWM method and a PFM method to the other according to the result of the comparison. According to the control method of the DC-DC converter in accordance with a second aspect of the present invention, the first and second mode selection reference voltages decrease associated with an increase in a direct-current input voltage. Therefore, an operation mode can be switched in a region in which the alternating-current component (ripple) included in the error signal is small. Thus, an operation of the DC-DC converter can be stable.

According to the present invention, it is possible to provide the DC-DC converter and a control method thereof that are capable of stably switching the operation mode when an input voltage varies.

### BRIEF DESCRIPTION OF THE DRAWINGS

The above and other aspects, advantages and features will be more apparent from the following description of certain embodiments taken in conjunction with the accompanying drawings, in which:

FIG. 1 is a block diagram showing a configuration of a DC-DC converter 100 according to a first embodiment;

FIG. 2 is a signal timing chart of the DC-DC converter 100;

FIG. 3 is a graph showing a variation of a direct-current output voltage Vout when a PWM control is performed;

FIG. 4 is a graph schematically showing a relation between mode selection reference voltages Vmh and Vml, and an error signal Ve at an input of the DC-DC converter 100 when a direct-current input voltage Vin is high;

FIG. 5 is a circuit diagram of a mode selection reference voltage generator 3;

FIG. 6 is a graph showing a variation of a hysteresis width of the DC-DC converter 100 when the direct-current input voltage Vin is high;

FIG. 7 is a circuit diagram of an operation mode selector 4;

FIG. 8 is a graph showing an operation mode switching in a DC-DC converter disclosed in Japanese Unexamined Patent Application Publication No. 2003-219637;

FIG. 9 is a graph showing an operation mode switching when an input voltage of the DC-DC converter disclosed in Japanese Unexamined Patent Application Publication No. 2003-219637 is low; and

FIG. 10 is a graph showing an operation mode switching when an input voltage of the DC-DC converter disclosed in Japanese Unexamined Patent Application Publication No. 2003-219637 is high.

### DETAILED DESCRIPTION

### First Embodiment

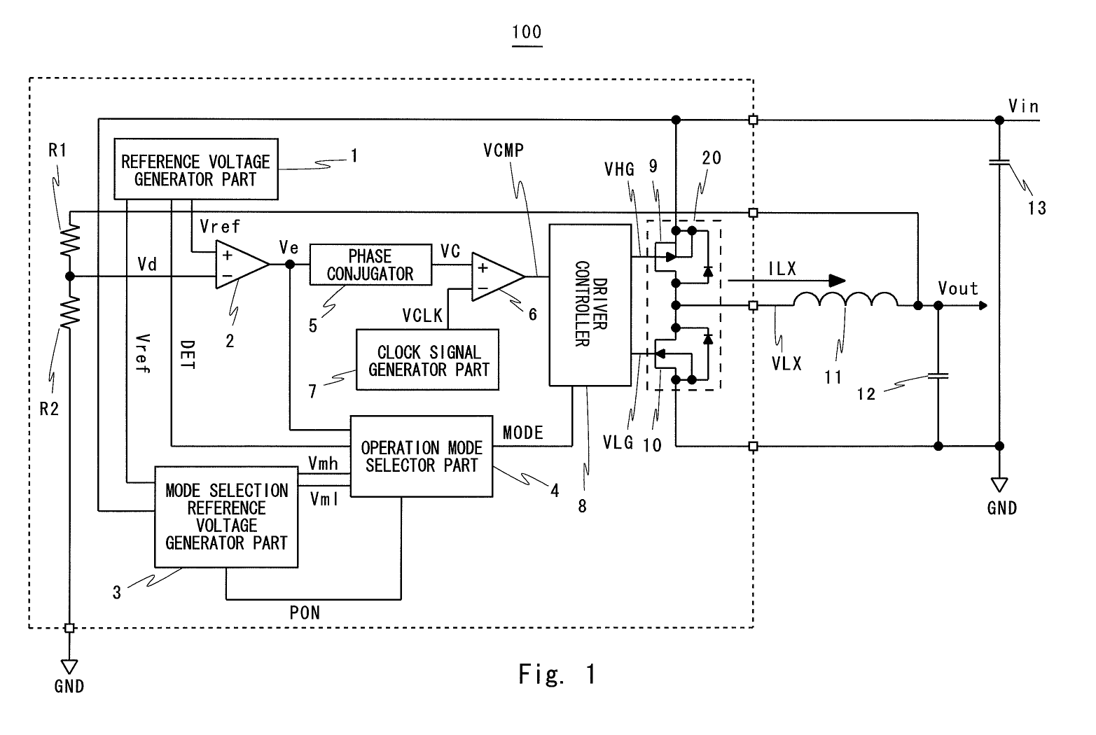

Hereinafter, embodiments incorporating the present invention are described with reference to the drawings. FIG. 1 is a block diagram showing a configuration of a DC-DC converter 100 according to a first embodiment. An input capacitor 13 is connected between a direct-current input voltage Vin and a ground voltage GND of the DC-DC converter 100. Further, a driver PMOS transistor 9 and a driver NMOS transistor 10, which are connected in series, are connected between the direct-current input voltage Vin and the ground voltage GND. The direct-current input voltage Vin is supplied to one input terminal of a mode selection reference voltage generator 3. A direct-current output voltage Vout is output from a connection point between the driver PMOS transistor 9 and the driver NMOS transistor 10 via an inductor 11. A current ILX is a current flowing into the inductor 11. A voltage VLX is a voltage at a terminal of the inductor 11 which is in a side of the driver PMOS transistor 9 and the driver NMOS transistor 10.

An output capacitor 12 is connected between the direct-current output voltage Vout and the ground voltage GND. Further, resistors R1 and R2, which are connected in series, are connected between the direct-current output voltage Vout and the ground voltage GND. A connection point between the resistors R1 and R2 is connected to one input terminal (inverting input terminal) of an error amplifier 2.

A reference voltage generator 1 is connected to the other input terminal (non-inverting input terminal) of the error amplifier 2 and the other input terminal of the mode selection reference voltage generator 3. An output terminal of the error amplifier 2 is connected to an input side of an operation mode selector 4. Further, the output terminal of the error amplifier 2 is connected to one input terminal (non-inverting input terminal) of a PWM comparator 6 via a phase conjugator 5.

Two output terminals of the mode selection reference voltage generator 3 are connected to the input side of the operation mode selector 4. An output terminal of the operation mode selector 4 is connected to one input terminal of a driver controller 8. The other input terminal of the PWM comparator 6 is connected to an output terminal of a clock signal generator 7. An output terminal of the PWM comparator 6 is connected to the other input terminal of the driver controller 8. One output terminal of the driver controller 8 is connected to the gate of the driver PMOS transistor 9. The other output terminal of the driver controller 8 is connected to the gate of the driver NMOS transistor 10. The driver PMOS transistor 9 and the driver NMOS transistor 10 function as a driver circuit 20 of the DC-DC converter 100.

In sum, the resistor R2, the error amplifier 2, the phase conjugator 5, the PWM comparator 6 and the driver controller 8 observe the direct-current output voltage Vout, and constitute a voltage feedback loop that feeds back the observation result as input signals to the driver PMOS transistor 9 and driver NMOS transistor 10.

Next, an operation of the DC-DC converter 100 is described. The resistors R1 and R2 divide the direct-current output voltage Vout of the DC-DC converter 100, so that a divided voltage Vd is generated. The reference voltage generator 1 generates a reference voltage Vref, and outputs the reference voltage Vref to the error amplifier 2 and the mode selection reference voltage generator 3. The error amplifier 2 amplifies the differential voltage between the divided voltage Vd and the reference voltage Vref. Then, the error amplifier 2 outputs the amplified voltage as an error signal Ve.

The mode selection reference voltage generator 3 generates mode selection reference voltages Vmh and Vml from the direct-current input voltage Vin and the reference voltage Vref. Then, the mode selection reference voltage generator 3 outputs the mode selection reference voltages Vmh and Vml to the operation mode selector 4. Note that the mode selection reference voltage Vmh indicates a PFM→PWM switching level voltage and the mode selection reference voltage Vml indicates a PWM→PFM switching level voltage. Further, ON/OFF of the mode selection reference voltage generator 3 is controlled according to a signal PON output from the operation mode selector 4.

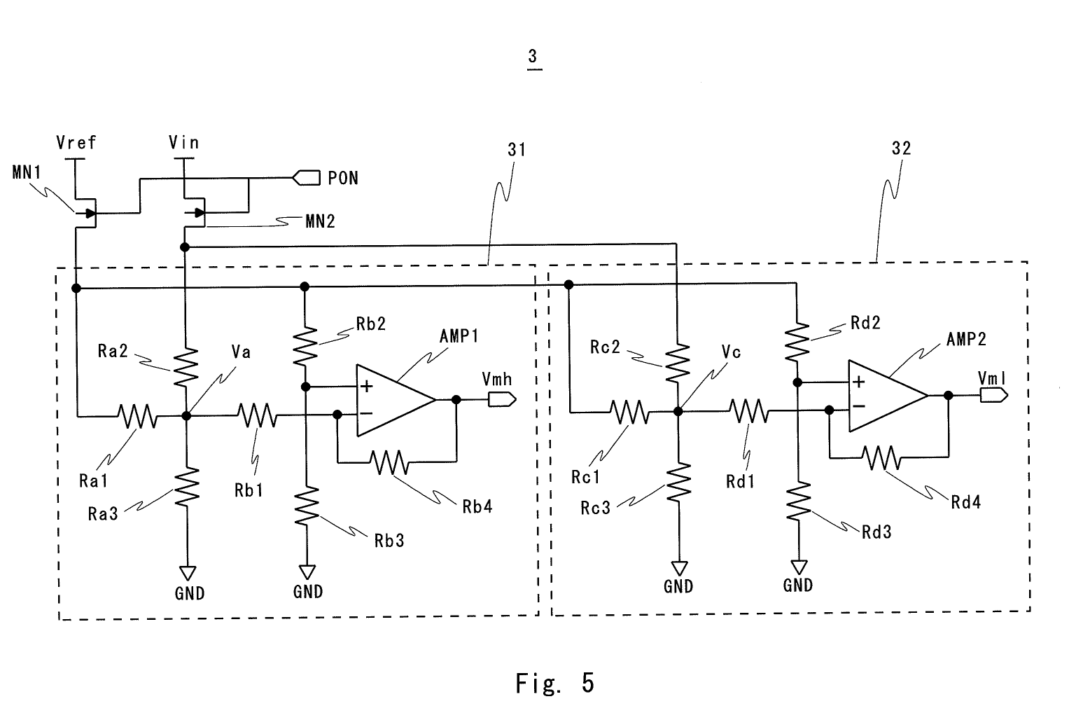

When the signal PON is “1”, NMOS transistors MN1 and MN2 (see FIG. 5) turn on. Thus, the mode selection reference voltages Vmh and Vml are generated by the mode selection reference voltage generator 3. Note that Vmh>Vml. Hereinafter, Vhy (=Vmh−Vml) is referred as a hysteresis width.

The operation mode selector 4 compares the error signal Ve with the mode selection reference voltages Vmh and Vml. When Ve≧Vmh (the case of PFM→PWM switching) after the comparison, “0” is output as an operation mode signal. On the other hand, when Ve≦Vml (the case of PWM→PFM switching), “1” is output as the operation mode signal.

Further, the operation mode selector 4 outputs the signal PON to the mode selection reference voltage generator 3 according to a signal DET and the mode selection reference voltage Vmh. For example, the signal PON is “0” when Vmh≦DET, and the signal PON is “1” when Vmh>DET. The mode selection reference voltage generator 3 turns on when the signal PON is “1”, and turns off when the signal PON is “0”.

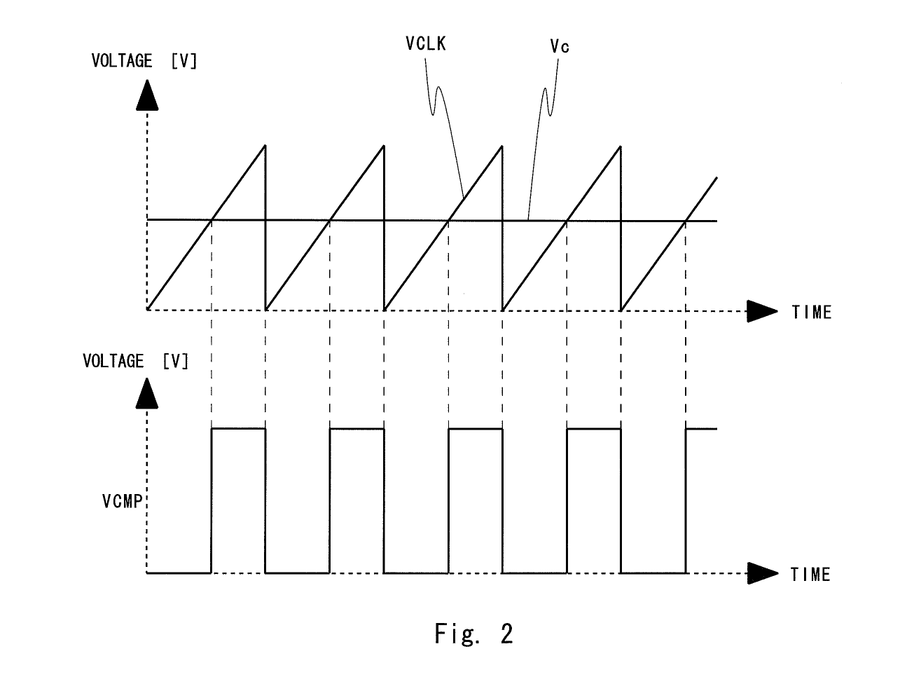

The phase conjugator 5 corrects a signal phase and prevents an oscillation in the voltage feedback loop described above, and generates a signal VC from the error signal Ve. The clock signal generator 7 outputs a clock signal VCLK, which has a saw-tooth waveform, to the PWM comparator 6. The PWM comparator 6 generates a signal VCMP from the signal VC and the clock signal VCLK, and outputs the signal VCMP to the driver controller 8. FIG. 2 is a signal timing chart of the DC-DC converter 100. As shown in FIG. 2, the signal VCMP is “1” when VC≦VCLK. The signal VC varies following the direct-current output voltage Vout, so that a duty of the signal VCMP varies according to the direct-current output voltage Vout. In sum, the duty of the signal VCMP decreases in proportion to the direct-current output voltage Vout.

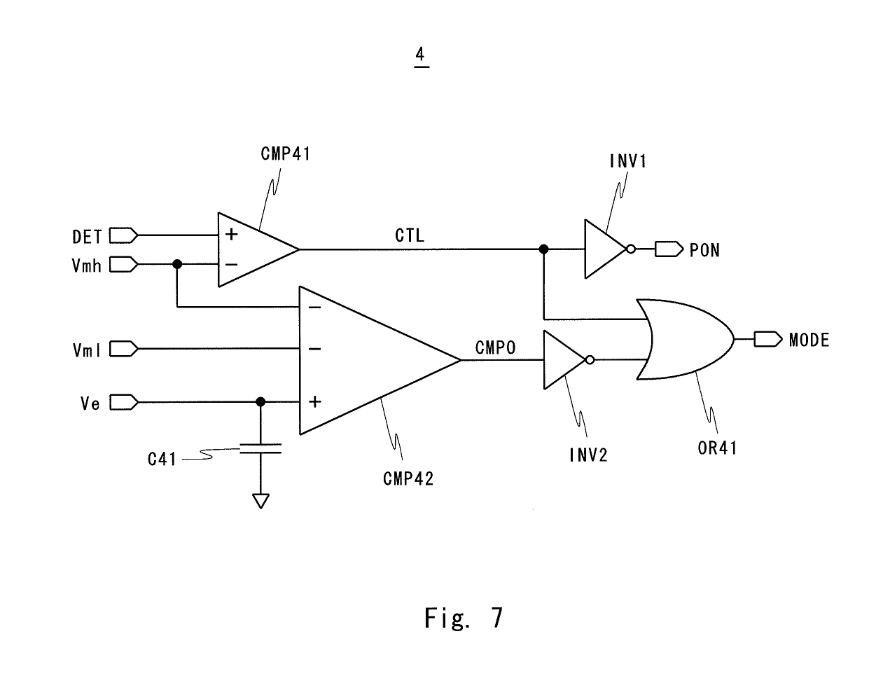

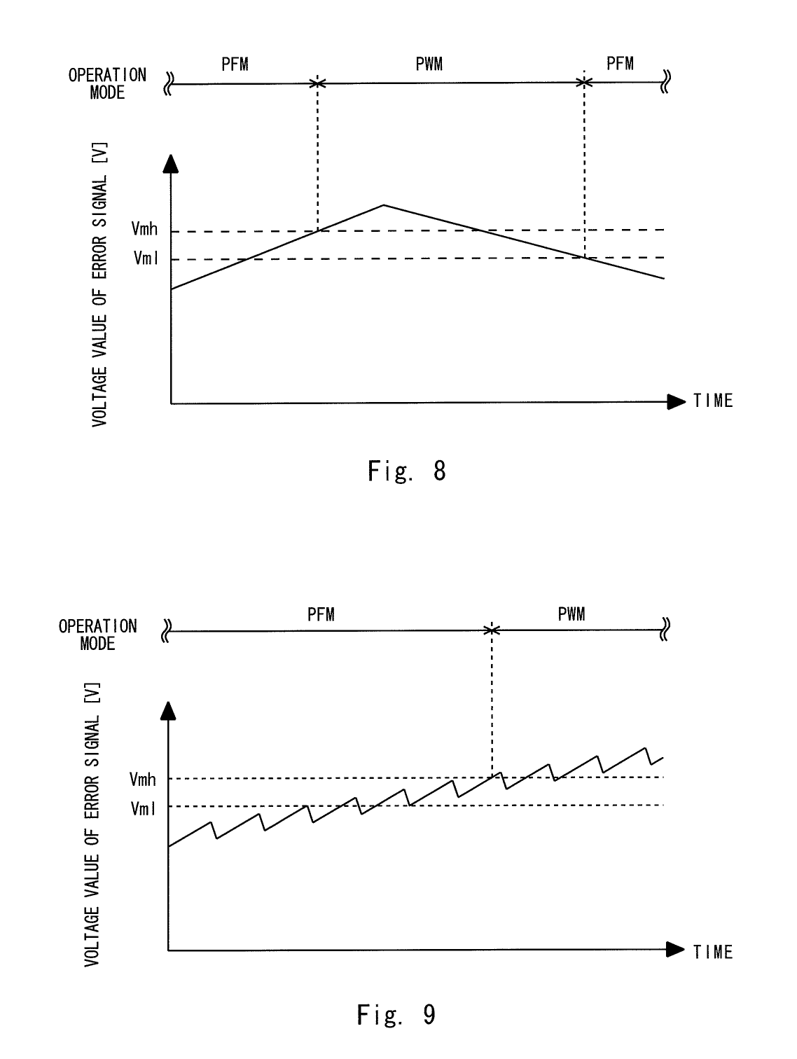

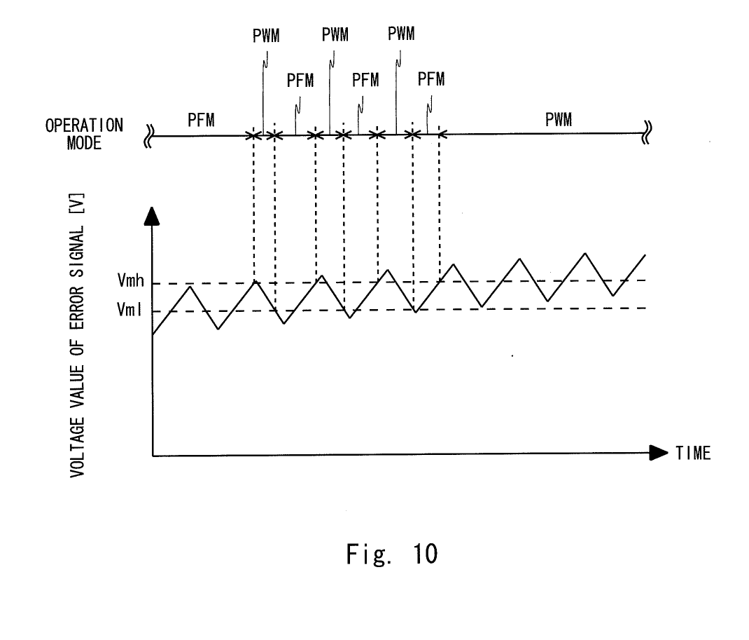

For example, the driver controller 8 performs a PWM control when an operation mode signal MODE is “0”. Meanwhile, the driver controller 8 performs a PFM control when the operation mode signal MODE is “1”. Gate voltages VHG and VLG, duties of which are adjusted based on the signal VCMP, are generated by the driver controller 8 when the PWM control is performed. On the other hand, the gate voltages VHG and VLG, frequencies of which are adjusted based on the signal VCMP and the operation mode signal MODE output from an OR circuit 41 shown in FIG. 7, are generated by the driver controller 8 when the PFM control is performed.

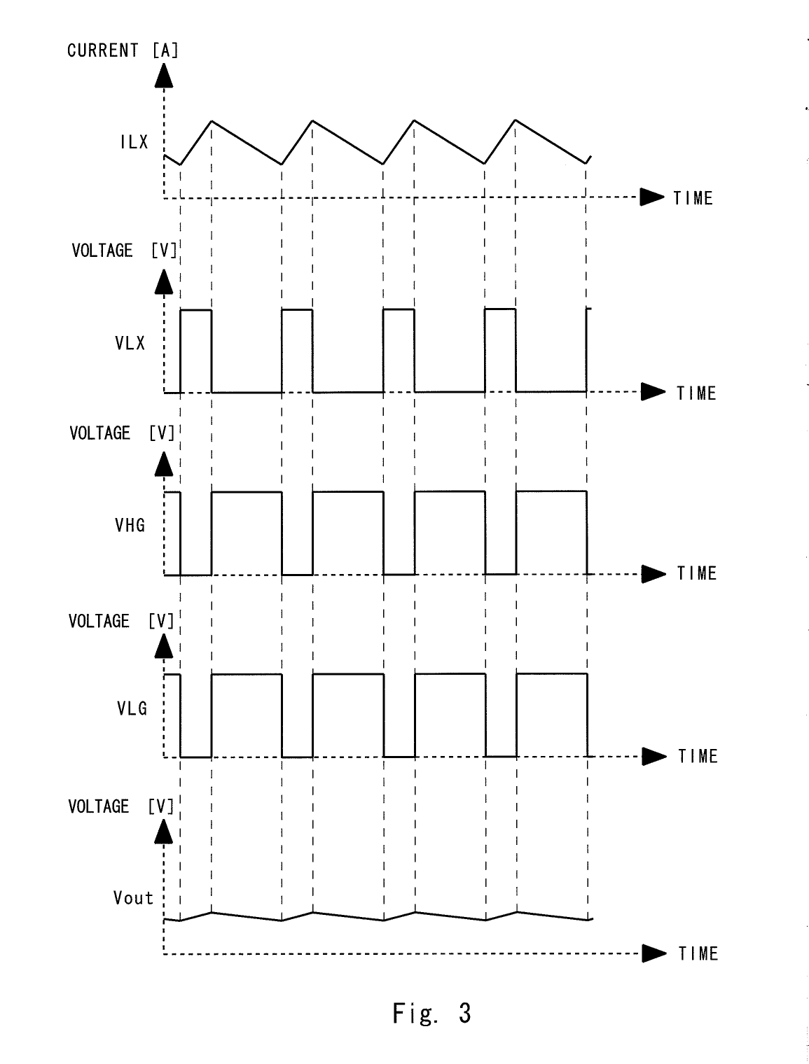

Subsequently, a relation between an operation of the inductor 11 and the direct-current output voltage Vout is described. First, the case of performing the PWM control is described. FIG. 3 is a graph showing a variation of the direct-current output voltage Vout when the PWM control is performed.

The gate voltages VHG and VLG are controlled so that the driver PMOS transistor 9 and the driver NMOS transistor 10 alternately turn on and off. When the driver PMOS transistor 9 turns on and the driver NMOS transistor 10 turns off, the inductor 11 accumulates electromagnetic energy. Then, the driver PMOS transistor 9 turns off and the driver NMOS transistor 10 turns on. Thus, electromotive force is generated in the inductor 11 by the energy accumulated in the inductor 11. Therefore, a current flows through the driver NMOS transistor 10. In this way, the direct-current output voltage Vout increases. The same is true in the case of performing the PFM control.

In other words, the DC-DC converter 100 generates the direct-current output voltage Vout according to an operation (ON/OFF) of the driver circuit 20 constituted of the driver PMOS transistor 9 and the driver NMOS transistor 10. In sum, when the driver circuit 20 turns on (the driver PMOS transistor 9 turns on and the driver NMOS transistor 10 turns off), the inductor 11 accumulates the electromagnetic energy. Further, when the driver circuit 20 turns off (the driver PMOS transistor 9 turns off and the driver NMOS transistor 10 turns on), the inductor 11 releases the accumulated electromagnetic energy. Therefore, the DC-DC converter 100 can function as a step-down type DC-DC converter.

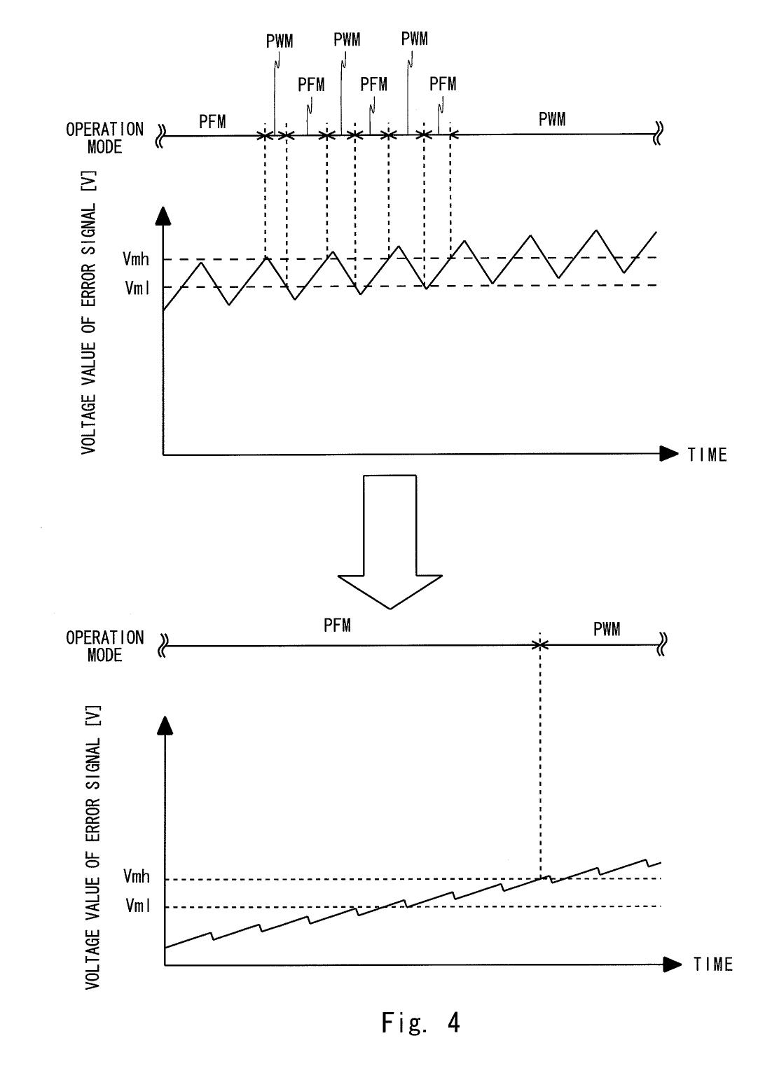

Hence, the mode selection reference voltages Vmh and Vml can be set within a region in which a ripple of the direct-current output voltage does not traverse the hysteresis width Vhy. FIG. 4 is a graph schematically showing a relation between the mode selection reference voltages Vmh and Vml, and the error signal Ve at an input of the DC-DC converter 100 when the direct-current input voltage Vin is high. As shown in the upper stage of FIG. 4, when the direct-current input voltage Vin is high and the mode selection reference voltages Vmh and Vml do not vary, a ripple of the error signal Ve is large. Therefore, the operation mode is continually switched.

According to the configuration, as shown in the lower stage of FIG. 4, the mode selection reference voltages Vmh and Vml can be decreased associated with an increase in the direct-current input voltage Vin. In sum, the mode selection reference voltages Vmh and Vml can be decreased associated with an increase in the ripple of the error signal Ve. Thus, it is possible to prevent the ripple of the error signal Ve from traversing the hysteresis width Vhy. Therefore, according to the configuration, the operation of the DC-DC converter can be stable.

Subsequently, the mode selection reference voltage generator 3 is particularly described. FIG. 5 is a circuit diagram of the mode selection reference voltage generator 3. As shown in FIG. 5, the mode selection reference voltage generator 3 includes a first voltage generator 31, a second voltage generator 32, the NMOS transistors MN1 and MN2.

In the first voltage generator 31, one terminal of a resistor Ra1, one terminal of a resistor Ra2, one terminal of a resistor Ra3 and one terminal of a resistor Rb1 are reciprocally connected. The other terminal of the resistor Ra1 receives the reference voltage Vref via the NMOS transistor MN1. The other terminal of the resistor Ra2 receives the direct-current input voltage Vin via the NMOS transistor MN2. The other terminal of the resistor Ra3 receives the ground voltage GND. The other terminal of the resistor Rb1 is connected to one input terminal (inverting input terminal) of an amplifier AMP1.

Resistors Rb2 and Rb3 are connected in series between the source of the NMOS transistor MN1 and the ground voltage GND. A connection point between the resistors Rb2 and Rb3 is connected to the other input terminal (non-inverting input terminal) of the amplifier AMP1. Further, a resistor Rb4 is connected between the non-inverting input terminal and an output terminal of the amplifier AMP1. The mode selection reference voltage Vmh is output from the output terminal of the amplifier AMP1.

A voltage Va at a connection point of the resistors Ra1 to Ra3 and Rb1 is expressed by the following equation (1).

$$Va = \frac{{X}_{1}}{( {X}_{1} + Ra 1 )} \cdot Vin + \frac{{Y}_{1}}{( {Y}_{1} + Ra 2 )} \cdot Vref \qquad ( 1 )$$

Note that, X1 is expressed by the following equation (2), and Y1 is expressed by the following equation (3). The voltage Va is set to satisfy Va<Vref when the direct-current input voltage Vin is maximum.

$$\begin{matrix}{X}_{1} = \frac{Ra 1 \times Ra 3}{( Ra 1 + Ra 3 )} & ( 2 ) \\ {Y}_{1} = \frac{Ra 2 \times Ra 3}{( Ra 2 + Ra 3 )} & ( 3 )\end{matrix}$$

Therefore, the voltage Va is determined by the resistance values of the resistors Ra1 to Ra3.

When it is assumed that Rb1=Rb4 and Rb2=Rb3, the mode selection reference voltage Vmh is expressed by the following equation (4).

$$Vmh = \frac{Rb 1}{Rb 4} ( Vref - Va ) \qquad ( 4 )$$

The second voltage generator 32 has a configuration in which the resistors Ra1 to Ra3, the resistors Rb1 to Rb4 and the amplifier AMP1 of the first voltage generator 31 are replaced by resistors Rc1 to Rc3, resistors Rd1 to Rd4 and an amplifier AMP2, respectively.

A voltage Vc at a connection point between the resistors Rc1 to Rc3 and Rd1 is expressed by the following equation (5).

$$Vc = \frac{{X}_{2}}{( {X}_{2} + Rc 1 )} \cdot Vin + \frac{{Y}_{2}}{( {Y}_{2} + Rc 2 )} \cdot Vref \qquad ( 5 )$$

Note that, X1 is expressed by the following equation (6), and Y1 is expressed by the following equation (7). The voltage Vc is set to satisfy Vc<Vref when the direct-current input voltage Vin is maximum.

$$\begin{matrix}{X}_{2} = \frac{Rc 1 \times Rc 3}{( Rc 1 + Rc 3 )} & ( 6 ) \\ {Y}_{2} = \frac{Rc 2 \times Rc 3}{( Rc 2 + Rc 3 )} & ( 7 )\end{matrix}$$

Therefore, the voltage Vc is determined by the resistance values of the resistors Rc1 to Rc3.

When it is assumed that Rd1=Rd4 and Rd2=Rd3, the mode selection reference voltage Vml is expressed by the following equation (8).

$$Vml = \frac{Rd 1}{Rd 4} ( Vref - Vc ) \qquad ( 8 )$$

As expressed by the equations (4) and (8), the mode selection reference voltages Vmh and Vml are functions of the reference voltage Vref and the direct-current input voltage Vin. Therefore, the mode selection reference voltages Vmh and Vml decrease in proportion to the direct-current input voltage Vin, and increase in proportion to the reference voltage Vref.

Further, in the above-mentioned example, a relation of (Rb1/Rb4)=(Rd1/Rd4) is satisfied. Hence, even if the direct-current input voltage Vin varies, the hysteresis width Vhy can be maintained at constant value.

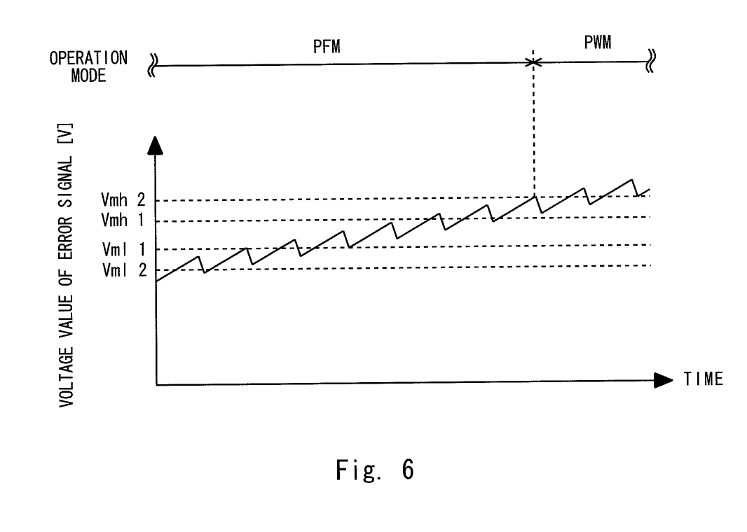

Furthermore, when a relation of (Rb1/Rb4)<(Rd1/Rd4) is set, the hysteresis width Vhy can be increased associated with the increase in the direct-current input voltage Vin. Thus, operation mode stabilization can be achieved more certainly. FIG. 6 is a graph showing a variation of the hysteresis width of the DC-DC converter 100 when the direct-current input voltage Vin is high. In FIG. 6, mode selection reference voltages Vmh2 and Vml2 when the hysteresis width is expanded and the mode selection reference voltages Vmh1 and Vml1 when the hysteresis width is not expanded are represented. As shown in FIG. 6, a probability that the ripple of the error signal Ve traverses the hysteresis width becomes lower by the hysteresis width being expanded. Therefore, the operation mode switching can be performed more stably.

Further, the signal PON output from the operation mode selector 4 is applied to the gates of the NMOS transistors MN1 and MN2. For example, when the signal PON is “0”, the NMOS transistors MN1 and MN2 turn off. Thus, the mode selection reference voltage generator 3 turns off.

Subsequently, the operation mode selector 4 is particularly described. FIG. 7 is a circuit diagram of the operation mode selector 4. As shown in FIG. 7, the operation mode selector 4 includes a comparator CMP41, a mode switching comparator CMP42, inverters INV1 and INV2, an OR circuit OR41, and a capacitor C41.

One input terminal (non-inverting input terminal) of the comparator CMP41 receives the signal DET output from a reference voltage generator. The other input terminal (inverting input terminal) of the comparator CMP41 receives the mode selection reference voltage Vmh. A signal CTL is output from an output terminal of the comparator CMP41 to the inverter INV1 and the OR circuit OR41. The inverter INV1 outputs the signal PON, which is an inverted signal of the signal CTL, to the mode selection reference voltage generator 3.

The mode selection reference voltages Vmh and Vml, and the error signal Ve are supplied to an input side of the mode switching comparator CMP42. Note that noise of the error signal Ve is eliminated by the capacitor C41. A signal CMPO is output from an output terminal of the mode switching comparator CMP42 to the inverter INV2. The inverter INV2 outputs the signal, which is an inverted signal of the signal CMPO, to the OR circuit OR41. The OR circuit OR41 outputs the operation mode signal MODE to the driver controller 8.

The selection comparator CMP42 in the operation mode selector 4 compares the mode selection reference voltages Vmh and Vml with the error signal Ve. For example, when Ve≧Vmh (the case of the PFM→PWM switching), the mode switching comparator CMP42 outputs “1” as the signal CMPO. On the other hand, when Ve≦Vml (the case of the PWM→PFM switching), the mode switching comparator CMP42 outputs “0” as the signal CMPO. When the error signal Ve is within the hysteresis width Vhy (Vmh<Ve<Vml), the mode switching comparator CMP42 maintains the signal CMPO as it is.

The inverter INV2 inverts the signal CMPO. Thus, when the PFM→PWM switching is performed, “0” is output to the OR circuit OR41. On the other hand, when the PWM→PFM switching is performed, “1” is output to the OR circuit OR41.

Further, the comparator CMP41 compares a voltage value of the signal DET with a value of the mode selection reference voltage Vmh. As a result, “1” is output as the signal CTL when Vmh≦DET. On the other hand, “0” is output as the signal CTL when Vmh>DET.

When both of the signal CMPO and the signal CTL are “0”, the OR circuit OR41 outputs “0” as the operation mode signal MODE. In other cases, “1” is output as the operation mode signal MODE.

The inverter INV1 outputs the signal PON which is an inverted signal of the signal CTL. Thus, the mode selection reference voltage generator 3 turns off when Vmh≦DET, and turns on when Vmh>DET.

### Other Embodiments

The present invention is not limited to the embodiment described above, but may be changed as appropriate without departing from the spirit of the present invention. For example, although the step-down type DC-DC converter is explained in the embodiment described above, the present invention can be applied to a step-up type DC-DC converter.

Further, although the DC-DC converter is explained in the embodiment described above, the present invention can be applied to other types of converters in order to prevent the operation mode destabilization by the ripple.

While the invention has been described in terms of several embodiments, those skilled in the art will recognize that the invention can be practiced with various modifications within the spirit and scope of the appended claims and the invention is not limited to the examples described above.

Further, the scope of the claims is not limited by the embodiments described above.

Furthermore, it is noted that, Applicant's intent is to encompass equivalents of all claim elements, even if amended later during prosecution.

What is claimed is:

1. A DC-DC converter comprising:
an error generator that generates an error signal based on a direct-current output voltage;
a mode selection reference voltage generator that generates a first mode selection reference voltage and a second mode selection reference voltage lower than the first mode selection reference voltage, the first and second mode selection reference voltages varying based on amplitude of an alternating-current component included in the error signal;
an operation mode selector that compares the error signal with the first and second mode selection reference voltages; and
a driver controller that switches a generating method of the direct-current output voltage from one of a PWM method and a PFM method to the other according to the result of the comparison.

2. The DC-DC converter according to claim 1, wherein the alternating-current component included in the error signal is generated by transmission of an alternating-current component included in the direct-current output voltage.

3. The DC-DC converter according to claim 1, wherein the first and second mode selection reference voltages decrease according to an increase in the alternating-current component included in the error signal.

4. The DC-DC converter according to claim 1, wherein a difference between the first and second mode selection reference voltages increases according to an increase in the alternating-current component included in the error signal.

5. The DC-DC converter according to claim 1, wherein the mode selection reference voltage generator generates the first and second mode selection reference voltages based on a direct-current input voltage supplied to the DC-DC converter.

6. The DC-DC converter according to claim 5, further comprising a reference voltage generator that generates a first reference voltage,
wherein the mode selection reference voltage generator generates the first and second mode selection reference voltages in proportion to a difference between the direct-current input voltage and the first reference voltage.

7. The DC-DC converter according to claim 5, wherein the alternating-current component included in the error signal increases according to an increase in an alternating-current component included in the direct-current input voltage.

8. The DC-DC converter according to claim 5, further comprising:
a driver circuit that is ON/OFF controlled by the driver controller; and
an inductor that accumulates electromagnetic energy by flowing a current thereinto according to the direct-current input voltage when the driver circuit turns on and generates the direct-current output voltage by releasing the accumulated electromagnetic energy when the driver circuit turns off.

9. The DC-DC converter according to claim 8, wherein the driver controller controls ON/OFF of the driver circuit by the PWM method when the error signal is equal to or more than the first mode selection reference voltage and controls ON/OFF of the driver circuit by the PFM method when the error signal is equal to or less than the second mode selection reference voltage.

10. The DC-DC converter according to claim 8, wherein
the reference voltage generator further generates a second reference voltage,
the operation mode selector compares the first mode selection reference voltage with the second reference voltage, and
the driver controller controls ON/OFF of the driver circuit by the PFM method when the first mode selection reference voltage is equal to or less than the second reference voltage.

11. The DC-DC converter according to claim 8, wherein the alternating-current component included in the direct-current output voltage is generated by ON/OFF of the driver circuit.

12. An information processing device that incorporates the DC-DC converter according to claim 1.

13. A control method of a DC-DC converter comprising:
generating an error signal based on a direct-current output voltage;
changing a first mode selection reference voltage and a second mode selection reference voltage lower than the first mode selection reference voltage based on amplitude of an alternating-current component included in the error signal;
comparing the error signal with the first and second mode selection reference voltages; and
switching a generating method of the direct-current output voltage from one of a PWM method and a PFM method to the other according to the result of the comparison.

14. The control method of the DC-DC converter according to claim 13, wherein the alternating-current component included in the error signal is generated by transmission of an alternating-current component included in the direct-current output voltage.

15. The control method of the DC-DC converter according to claim 13, wherein the first and second mode selection reference voltages are decreased according to an increase in the alternating-current component included in the error signal.

16. The control method of the DC-DC converter according to claim 13, wherein a difference between the first and second mode selection reference voltages is increased according to an increase in the alternating-current component included in the error signal.

17. The control method of the DC-DC converter according to claim 13, wherein the first and second mode selection reference voltages are generated based on a direct-current input voltage supplied to the DC-DC converter.

18. The control method of the DC-DC converter according to claim 17, further comprising generating a first reference voltage,
wherein the first and second mode selection reference voltages are generated in proportion to a difference between the direct-current input voltage and the first reference voltage.

19. The control method of the DC-DC converter according to claim 17, wherein the alternating-current component included in the error signal increases according to an increase in the direct-current input voltage.

20. The control method of the DC-DC converter according to claim 17, wherein
electromagnetic energy is accumulated in an inductor by flowing a current into the inductor according to the direct-current input voltage, and
the direct-current output voltage is generated by releasing the accumulated electromagnetic energy in the inductor.
